(19) United States
(12) Patent Application Publication
(10) Pub. No.: US 2026/0133163 A1
(43) Pub. Date: May 14, 2026

(54) SYSTEM FOR DETERMINING THE DIRECTION OF A SURFACE ACOUSTIC WAVE

(71) Applicant: Toyota Motor Engineering & Manufacturing North America, Inc., Plano, TX (US)

(72) Inventors: Taehwa Lee, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/926,789

(22) Filed: Oct. 25, 2024

(51) Int. Cl. G01N 29/04; G01N 29/24; G01N 29/44

(52) U.S. Cl. CPC G01N 29/041; G01N 29/2418; G01N 29/4454; G01N 2291/01

(57) ABSTRACT

Systems for determining the direction of a surface acoustic wave are described herein. In one example, a system for determining the direction of the surface acoustic wave includes a resonator having a top surface and a sensor configured to output a signal representative of displacements of the top surface at different locations when a surface acoustic wave travels along a support surface that supports the resonator. This signal can then be utilized to determine the direction of the surface acoustic wave.

### TECHNICAL FIELD

The subject matter described herein relates, in general, to systems for determining the direction of a surface acoustic wave.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

A surface acoustic wave is an acoustic wave that travels along the surface of an elastic material, with its amplitude decaying exponentially with depth into the material. Current methodologies for determining the particular direction of a surface acoustic wave typically involve utilizing multiple detectors placed at a sufficient distance to determine a phase difference and/or utilizing multiple resonators, each having one or more detectors.

### SUMMARY

This section generally summarizes the disclosure and is not a comprehensive explanation of its full scope or all its features.

In one embodiment, a system for determining the direction of the surface acoustic wave includes a resonator having a top surface and a sensor configured to output a signal representative of displacements of the top surface at different locations, such as two different locations, when a surface acoustic wave travels along a support surface that supports the resonator. This signal can then be utilized to determine the direction of the surface acoustic wave.

In another embodiment, a method includes the step of determining the direction of a surface acoustic wave based on a signal from a sensor configured to output a signal representative of displacements of the top surface of a resonator at different locations when a surface acoustic wave travels along a support surface that supports the resonator.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a system for determining the direction of a surface acoustic wave.

FIG. 2 illustrates a more detailed view of the data acquisition system for use with the system for determining the direction of a surface acoustic wave of FIG. 1.

FIG. 3 illustrates a method for determining the direction of a surface acoustic wave.

FIGS. 4A and 4B illustrate one example of the ratio of the displacements and the phase difference at two different locations, respectively, of a surface acoustic wave.

FIGS. 5A and 5B illustrate another example of the ratio of the displacements and the phase difference at two different locations, respectively, of a surface acoustic wave.

### DETAILED DESCRIPTION

Described are systems and methods for determining the angle of a surface acoustic wave. In one example, a system includes a resonator having a top surface and a sensor configured to output a signal representative of displacements of the top surface at different locations when a surface acoustic wave travels along the support surface that supports the resonator. The sensor can take any one of a number of different forms but may be one or more laser vibrometers. Using the displacement measurements at the different locations, a data acquisition system can determine the direction of the surface acoustic wave.

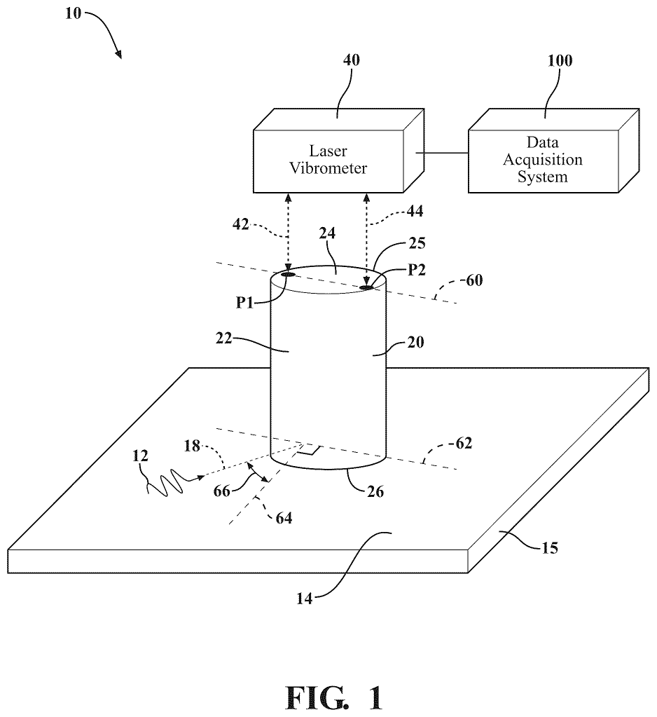

Referring to FIG. 1, illustrated is one example of a system 10 for determining the direction of a surface acoustic wave 12 traveling along the surface 14 of a material 15. Surface acoustic waves, such as the surface acoustic wave 12, are a type of sound wave that travels along the surface of a material, with its amplitude decaying exponentially with depth into the material. In some cases, surface acoustic waves may be confined to a depth of about one wavelength and are sensitive to changes in the surface properties of the material 15.

In this example, the system includes a resonator 20 in the shape of the cylinder that extends in a direction that is perpendicular to a plane that is defined by the surface 14. However, it should be understood that the resonator 20 may take any one of a number of different shapes. As such, the resonator 20, in this example, includes a circular top surface 24, a circular bottom surface 26, and a tubular surface 22 defined between the top surface 24 and the bottom surface 26. In this example, the top surface 24 and the bottom surface 26 are generally parallel with one another. However, it should be understood that the top surface 24 may be at an angle with respect to the bottom surface 26. Generally, the resonator 20 is made from a solid material, such as metal, plastic, and/or ceramic.

The resonator 20 is an acoustic resonator and is designed to amplify acoustic waves through resonance. As such, when acoustic waves enter the resonator 20, they cause the resonator to vibrate, creating standing waves within the structure. These standing waves enhance certain frequencies while dampening others. The cylindrical shape is particularly effective because it supports uniform wave propagation and can be easily tuned to desired frequencies by adjusting its dimensions.

Here, the bottom surface 26 of the resonator 20 is supported by the surface 14 of the material 15. When the surface acoustic wave 12 travels upon the surface 14 of the material 15, it has been observed that the top surface 24 of the resonator 20 will vibrate. In particular, it has been observed that the vibration or displacement at different locations on the top surface 24 may vary. As such, in this example, the displacement at the location P1 on the top surface 24 may differ from the location P2 on the top surface 24 when the surface acoustic wave 12 travels upon the surface 14 of the material 15.

The system 10 also includes one or more sensors for measuring the displacement at the locations P1 and P2. In this example, the one or more sensors may be a laser vibrometer 40. The laser vibrometer 40 is an instrument used for non-contact measurement of surface vibrations. In one example, the laser vibrometer 40 is positioned such that the laser vibrometer 40 emits one or more laser beams 42 and 44 toward the top surface 24. The laser vibrometer 40 may be configured to measure the Doppler shift in the reflected light caused by the motion of the top surface 24. This allows for a determination of the displacement and frequency without physically touching the resonator 20. In this example, the laser vibrometer 40 is capable of measuring displacements at the two different locations P1 and P2. For example, the laser vibrometer 40 may be a multi-beam laser vibrometer or may be a differential laser vibrometer that employs two laser beams aimed at different points on the top surface 24. However, in other configurations, multiple laser vibrometers may be utilized to measure the displacements at the two different locations.

The laser vibrometer 40 may output one or more signals indicating the displacements at the locations P1 and P2. In one particular example, the output signal of the laser vibrometer 40 may be a frequency-modulated signal generated by the Doppler shift in the frequency of the reflected laser beam due to the motion of the top surface 24 being measured. The frequency-modulated signal can be demodulated to derive the velocity or displacement of the top surface 24 by the data acquisition system 100.

The locations P1 and P2 may vary from application to application. Typically, the locations P1 and P2 should be at a sufficient distance so that the laser vibrometer 40 can measure differences in displacements at these two different locations. In one example, the locations P1 and P2 may be located near an edge 25 of the top surface 24 where the top surface comes into contact with the tubular surface 22. The locations P1 and P2 may be located at opposite ends of the edge 25 so as to maximize the distance between the locations P1 and P2. Of course, it should be understood that this is just an example of where P1 and P2 can be located on the top surface 24. Moreover, the locations of P1 and P2 can be anywhere on the top surface 24.

As will be explained in greater detail later in this description, the signals output by the laser vibrometer 40 are provided to a data acquisition system 100 that is able to determine the direction 18 of the surface acoustic wave 12. Generally, the direction 18 may be with respect to the line 60, as it is projected onto the surface 14 and shown as line 62. In some cases, the direction 18 may be in the form of an angle with respect to the line 62. In other cases, the angle may be shown as the angle 66, which is with respect to a line 64 that extends in the normal direction from the line 62.

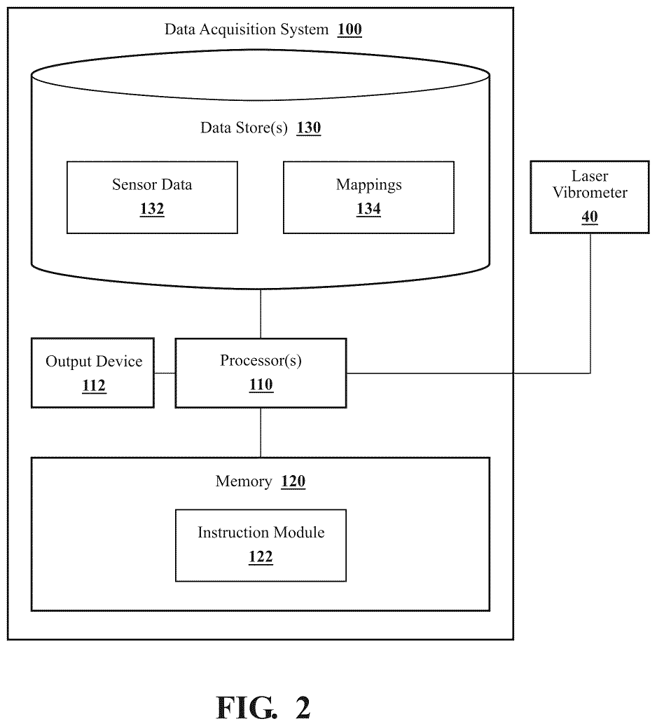

FIG. 2 illustrates a more detailed view of the data acquisition system 100 that will be utilized to determine the direction 18 of the surface acoustic wave, which may be represented as the angle 66. It should be understood that the data acquisition system 100 is just one example that the data acquisition system 100 may take. As such, the data acquisition system 100 may have more, fewer, or even different components than those illustrated in FIG. 2.

Here, in this example, the data acquisition system 100 includes one or more processor(s) 110. Accordingly, the processor(s) 110 may be a part of the data acquisition system 100, or the data acquisition system 100 may access the processor(s) 110 through a data bus or another communication path. In one or more embodiments, the processor(s) 110 is an application-specific integrated circuit that is configured to implement functions associated with an instruction module 122. In general, the processor(s) 110 is an electronic processor, such as a microprocessor, which is capable of performing various functions as described herein.

The data acquisition system 100 may also include an output device 112 that is in communication with the processor(s) 110. The output device 112 can be any device that is capable of outputting information generated by the data acquisition system 100, such as direction 18 of the surface acoustic wave 12. As such, the output device 112 could be a monitor, printer, virtual reality headset, or speaker or could act as a conduit to communicate with other devices (i.e., network access device), either wired or wirelessly.

In one example, the data acquisition system 100 includes a memory 120 that stores instruction module 122. The memory 120 may be a random-access memory (RAM), read-only memory (ROM), a hard disk drive, a flash memory, or other suitable memory for storing the instruction module 122. The instruction module 122 is, for example, computer-readable instructions that, when executed by the processor(s) 110 cause the processor(s) 110 to perform the various functions disclosed herein.

Furthermore, in one example, the data acquisition system 100 includes a data store 130. The data store 130 is, in one embodiment, an electronic data structure such as a database that is stored in the memory 120 or another memory and that is configured with routines that can be executed by the processor(s) 110 for analyzing stored data, providing stored data, organizing stored data, and so on. Thus, in one embodiment, the data store 130 stores data used by the instruction module 122 in executing various functions.

In this example, the data store 130 may include sensor data 132 collected from the laser vibrometer 40. The sensor data 132 may include any information output by the laser vibrometer 40 or information that is based on that outputted information. As such, this information could include information about the vibration characteristics of the top surface 24 at points P1 and P2. For example, the sensor data 132 may include the velocity of the top surface 24 at points P1 and P2 along the direction of the laser beam(s) of the laser vibrometer 40, providing this data as a continuous analog voltage proportional to the velocity of the top surface 24 at points P1 and P2. In addition, the sensor data 132 can also include data derived from these velocity outputs. For example, by integrating this velocity signal, the displacement of the top surface 24 at points P1 and P2 over time can also be determined. Additionally, the frequency of the vibrations may be extracted from the Doppler shift of the reflected laser beam of the laser vibrometer 40, and the amplitude of the vibrations, indicating how much the top surface 24 at points P1 and P2 is moving, can be derived from the velocity and displacement data.

The mappings 134 may be in the form of a reference table that references the ratio of the displacements of the top surface 24 at points P1 and P2 to a particular direction of the surface acoustic wave, which may be represented as an angle, such as the angle 66. Additionally or alternatively, instead of referencing the ratio of the displacements of the top surface 24 at points P1 and P2 to a particular direction of the surface acoustic wave, the mappings 134 may reference the phase difference between the displacements of the top surface 24 at points P1 and P2 to a particular direction of the surface acoustic wave. As such, the mappings 134 may be a two-dimensional lookup table that, in one column, has a set of known ratios and/or phase differences and, in a second column, has a corresponding direction of the surface acoustic wave 12, which may be represented as and angles, such as the angle 66. As such, utilizing this lookup table allows one to determine the direction of the surface acoustic wave 12 when one knows the ratios and/or phase differences previously described.

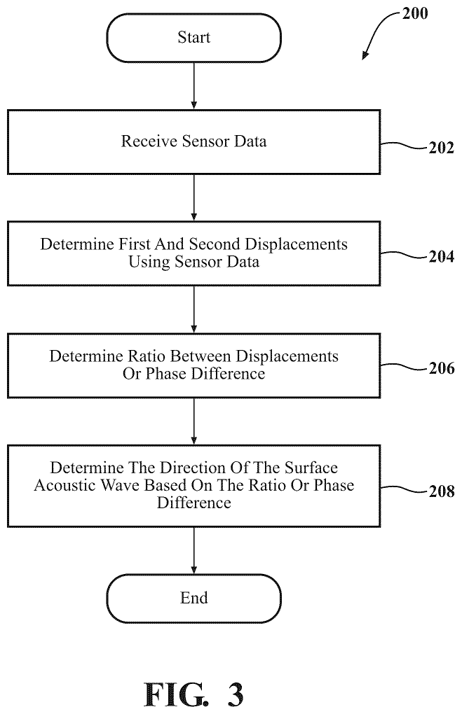

The instruction module 122 contains instructions that cause the processor(s) 110 to perform any of the methodologies described herein. With reference to FIG. 3, illustrated is a method 200 for determining the direction of a surface acoustic wave, such as the surface acoustic wave 12 of FIG. 1. The method 200 will be described from the viewpoint of the system 10 in FIG. 1 and the data acquisition system 100 of FIG. 2. However, it should be understood that this is just one example of implementing the method 200. While the method 200 is discussed in combination with the system 10 and the data acquisition system 100, it should be appreciated that the method 200 is not limited to being implemented within the system 10 and/or the data acquisition system 100, but is instead one example of a system that may implement the method 200. As such, the method 200 may be embodied within the instruction module 122 as processor-executable instructions that, when executed by the processor(s) 110, cause the processor(s) 110 to perform the method 200.

In step 202, the instruction module 122 contains instructions that cause the processor(s) 110 to receive sensor data 132 from the laser vibrometer 40. As explained previously, the sensor data 132 may include any information outputted by the laser vibrometer 40 or information that is based on that outputted information. As such, this information could include information about the vibration characteristics of the top surface 24 at points P1 and P2. For example, the sensor data 132 may include the velocity of the top surface 24 at points P1 and P2 along the direction of the laser beam(s) of the laser vibrometer 40, providing this data as a continuous analog voltage proportional to the velocity of the top surface 24 at points P1 and P2.

In step 204, the instruction module 122 contains instructions that cause the processor(s) 110 to determine the first and second displacements (i.e., the displacements at points P1 and P2 on the top surface 24) using the sensor data 132. In one example, this may be achieved by integrating a velocity signal outputted by the laser vibrometer 40, indicating the velocity of the displacement of the top surface 24 at points P1 and P2 over time. Additionally or alternatively, the step 204 may include determining the frequency of the vibrations extracted from the Doppler shift of the reflected laser beam of the laser vibrometer 40 and the amplitude of the vibrations, indicating how much the top surface 24 at points P1 and P2 are moving.

In step 206, the instruction module 122 contains instructions that cause the processor(s) 110 to determine the ratio between the displacements at points P1 and P2 or the phase differences at points P1 and P2. As to the ratio, the ratio may be determined by dividing the absolute value of P1 by the absolute value of P2, i.e. (|P1|/|P2|). As to the phase difference, this may be calculated by determining the difference in phase of the vibrations at points P1 and P2, i.e. Arg (P1/P2)(rad).

Once the ratio and/or the phase difference is known, the method 200 proceeds to step 208, wherein the instruction module 122 contains instructions that cause the processor(s) 110 to determine the direction of the surface acoustic wave 12 based on the ratio or the phase difference. As mentioned before, this may be accomplished by utilizing the mappings 134, which may be a two-dimensional lookup table that cross-references the ratio and/or the phase difference with a particular direction represented as an angle, such as the angle 66. Once the direction is known, the direction may be output to the output device 112 by the processor(s) 110.

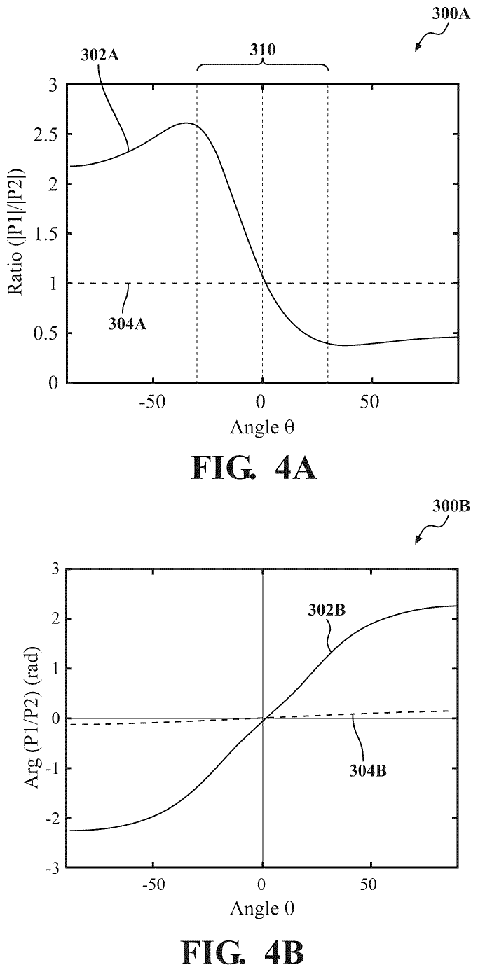

To better illustrate the relationship between the ratio and the phase difference with respect to the direction represented as an angle, such as the angle 66, reference is made to FIGS. 4A and 4B. In this example, the frequency of the surface acoustic wave 12 is approximately 103 MHz, which is the approximate resonant frequency of the resonator 20.

Moreover, FIG. 4A illustrates a chart 300A that shows the relationship 302A of the ratio, i.e. (|P1|/|P2|) with respect to the angle 66, which represents the direction of the surface acoustic wave 12. Here, the chart 300A shows a useful region 310 that can be used to determine the angle (direction) of the surface acoustic wave 12 when the ratio is known. Also, for the sake of comparison, shown is the relationship 304A of the displacements at the surface 14 if no resonator 20 was utilized. As illustrated, without the use of the resonator 20, there can be no usable relationship between the displacements of the surface 14 and the direction of the surface acoustic wave 12.

FIG. 4B illustrates a chart 300B that shows the relationship 302B of the phase difference, i.e., Arg (P1/P2)(rad), with respect to the angle 66, which represents the direction of the surface acoustic wave 12. Here, when one knows the phase difference, one can utilize the mappings 134 to determine the angle (direction) of the surface acoustic wave 12. Like before, for the sake of comparison, shown is the relationship 304B of the phase difference at the surface 14 if no resonator 20 was utilized. As illustrated, without the use of the resonator 20, there can be no usable relationship between the phase difference of the surface 14 and the direction of the surface acoustic wave 12.

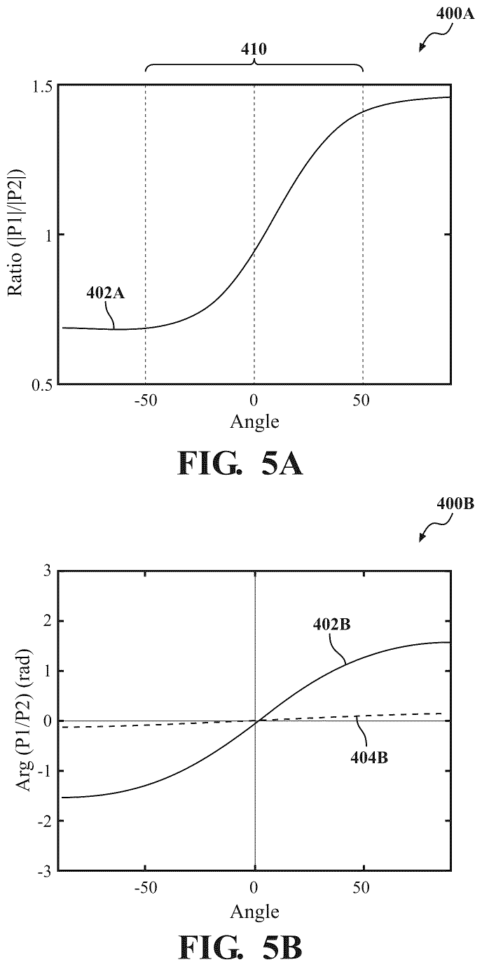

FIGS. 5A and 5B, like FIGS. 4A and 4B, also illustrate charts 400A and 400B of the relationship between the ratios and the phase differences, respectively, with respect to the direction of the surface acoustic wave 12. In this example, the frequency of the surface acoustic wave 12 is approximately 107 MHz, which is slightly above the resonant frequency of the resonator 20. As best shown in FIG. 5A, the relationship 402A between the ratio and the angle of the surface acoustic wave 12 has a slightly larger useful region 410.

FIG. 5B shows the relationship 402B of the phase difference, i.e., Arg (P1/P2)(rad), with respect to the angle 66, which represents the direction of the surface acoustic wave 12 when the surface acoustic wave 12 is approximately 107 MHz, which is slightly above the resonant frequency of the resonator 20. Here, the relationship 402B is slightly flatter than that of the relationship 302B. Also, for the sake of comparison, shown is the relationship 404B of the phase difference at the surface 14 if no resonator 20 was utilized.

As such, the systems and methods described herein are able to determine the direction of the surface acoustic wave by utilizing a resonator and measuring the displacements at two different locations on the top surface of the resonator. The systems and methods are advantageous over the prior art in that they do not require the use of multiple sensors, resonators, etc.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures. The embodiments are not limited to the illustrated structure or application.

The systems, components and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the preceding. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the preceding. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the preceding. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the preceding specification, indicating the scope hereof.

What is claimed is:

1. A system comprising:
a resonator having a top surface; and
a sensor configured to output a signal representative of displacements of the top surface at different locations when a surface acoustic wave travels along a support surface that supports the resonator.

2. The system of claim 1, further comprising:
a processor in communication with the sensor; and
a memory in communication with the processor, the memory having instructions that, when executed by the processor, causes the processor to determine a direction of the surface acoustic wave based on the signal from the sensor.

3. The system of claim 2, wherein the direction of the surface acoustic wave is with respect to a line defined between the different locations.

4. The system of claim 3, wherein the memory further comprises instructions that, when executed by the processor, causes the processor to:
determine, based on the signal from the sensor, a first displacement of the top surface at a first location of the different locations;
determine, based on the signal from the sensor, a second displacement of the top surface at a second location of the different locations;
calculate a ratio of the first displacement and the second displacement; and
determine the direction of the surface acoustic wave based on the ratio.

5. The system of claim 4, wherein the memory further comprises instructions that, when executed by the processor, causes the processor to determine the direction of the surface acoustic wave based on the ratio using the ratio and a mapping, wherein the mapping maps the ratio to the direction of the surface acoustic wave.

6. The system of claim 3, wherein the memory further comprises instructions that, when executed by the processor, causes the processor to:
determine, based on the signal from the sensor, a first displacement of the top surface at a first location of the different locations;
determine, based on the signal from the sensor, a second displacement of the top surface at a second location of the different locations;
calculate a phase difference between the first displacement and the second displacement; and
determine the direction of the surface acoustic wave based on the phase difference.

7. The system of claim 6, wherein the memory further comprises instructions that, when executed by the processor, causes the processor to determine the direction of the surface acoustic wave based on the phase difference using the phase difference and a mapping, wherein the mapping maps the phase difference to the direction of the surface acoustic wave.

8. The system of claim 1, wherein the resonator is a cylinder having the top surface and a bottom surface, wherein the bottom surface is in contact with the support surface.

9. The system of claim 8, wherein the resonator extends from the support surface in a direction that is perpendicular to a plane that is defined by the support surface.

10. The system of claim 1, wherein the sensor is at least one laser vibrometer.

11. The system of claim 10, wherein the at least one laser vibrometer is positioned such that beams emitted from the laser vibrometer are directed to the top surface of the resonator.

12. A method comprising determining a direction of a surface acoustic wave based on a signal from a sensor configured to output a signal representative of displacements of a top surface of a resonator at different locations when a surface acoustic wave travels along a support surface that supports the resonator.

13. The method of claim 12, wherein the direction of the surface acoustic wave is with respect to a line defined between the different locations.

14. The method of claim 13, further comprising:
determining, based on the signal from the sensor, a first displacement of the top surface at a first location of the different locations;
determining, based on the signal from the sensor, a second displacement of the top surface at a second location of the different locations;
calculating a ratio of the first displacement and the second displacement; and
determining the direction of the surface acoustic wave based on the ratio.

15. The method of claim 14, further comprising determining the direction of the surface acoustic wave based on the ratio using the ratio and a mapping, wherein the mapping maps the ratio to the direction of the surface acoustic wave.

16. The method of claim 13, further comprising:
determining, based on the signal from the sensor, a first displacement of the top surface at a first location of the different locations;
determining, based on the signal from the sensor, a second displacement of the top surface at a second location of the different locations;
calculating a phase difference between the first displacement and the second displacement; and
determining the direction of the surface acoustic wave based on the phase difference.

17. The method of claim 16, further comprising determining the direction of the surface acoustic wave based on the phase difference using the phase difference and a mapping, wherein the mapping maps the phase difference to the direction of the surface acoustic wave.

18. The method of claim 12, wherein the resonator is a cylinder having the top surface and a bottom surface, wherein the bottom surface is in contact with the support surface.

19. The method of claim 18, wherein the resonator extends from the support surface in a direction that is perpendicular to a plane that is defined by the support surface.

20. The method of claim 12, wherein the sensor is at least one laser vibrometer, wherein the at least one laser vibrometer is positioned such that beams emitted from the laser vibrometer are directed to the top surface of the resonator.
